(19) United States
(12) Patent Application Publication
(10) Pub. No.: US 2002/0079437 A1
(43) Pub. Date: Jun. 27, 2002

(54) Sound-collecting device

(75) Inventors: Alexander Paritsky, Modiin (IL); Alexander Kots, Ashdod (IL); Okihiro Kobayashi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Phone-OR Ltd., Or-Yehuda (IL)

(21) Appl. No.: 09/882,778

(22) Filed: Jun. 14, 2001

(30) Foreign Application Priority Data
Oct. 15, 1999 (JP) 11-294217

(51) Int. Cl. G01D 5/34; G06M 7/00

(52) U.S. Cl. 250/231.1; 250/221

(57) ABSTRACT

A device for collecting sounds comprises a plurality of microphones arranged in a predetermined pattern, wherein selected microphones are directed to an object. A microphone selection and control unit (60) selects at least one of a plurality of microphones and drives the selected microphone to collect sound from the object and output a signal. An optical microphone includes a vibration board (2) which vibrates by sound pressure, a light source (3) for emitting a light beam to the vibration board (2), a photodetector (5) which receives the light beam reflected from the vibration board (2) and produces a signal corresponding to the vibration of the vibration board (2), and a drive circuit (13) for supplying the light source (3) with predetermined current. A sound signal is extracted through a negative feedback circuit (100) that supplies the drive circuit (13) with a negative feedback signal consisting of part of the sound signal output from the selected optical microphone through the selection and control unit (60).

### BACKGROUND OF THE INVENTION

1. Technical Field

This invention relates to a sound collector, and it is related to the sound collector that uses an optical microphone that converts an oscillation of a diaphragm to an electric signal by using light.

2. Description of the Related Art

A rotation type microphone device is known as one of the conventional sound collectors. In the rotation type microphone device, multiple microphone is arranged in a circular frame, rotated electrically to the direction of the speaker, stopped at the direction of the applicable speaker, and the voice of the specific speaker is recorded. FIG. 8 shows one example of the conventional sound collectors in the block diagram. FIG. 8A shows the rotation type microphone device and FIG. 8B shows parallel type microphone device.

In the case of the rotation type microphone device shown in FIG. 8A, multiple microphones 20₁, 20₂, 20₃ . . . 20_{N} are arrayed in circular-shaped in a predetermined location of a circular frame 21 such as a table, each microphone is connected to a microphone drive unit 25. This microphone drive unit 25 is controlled by a rotation control unit 40, and outputs signal from the specific microphone by changing the driven microphone in a predetermined direction such as clockwise. Rotation control unit 40 chooses a microphone 20 in the direction of the specific speaker, a drive of the selected microphone by the microphone drive unit 25 is performed, and then takes out the voice through the amplifier 9.

Also in the parallel type microphone device shown in FIG. 8B, multiple microphone 30₁, 30₂, 30₃, . . .30_{N} are arrayed in the same way in a predetermined direction, and it is made to drive changeover electrically at a predetermined timing. Then, at least one microphone is selected by a choice control unit 40 and an aural signal from this microphone 30 is extracted and outputted.

However, each microphone used as the rotation type microphone or the parallel type microphone was a unidirectional or a single directivity. Therefore, because directivity in the direction of the specific speaker who becomes a sound collection object isn't sufficiently high, there was a fault that the voice from the speaker except for the sound collection object was outputted and that the influence of the surroundings noise was often taken. It is an object of this invention to solve the above-mentioned problem, and to provide a sound collector that enhances sound collection efficiency from the direction of sound collection object and decreases noise such as back noise.

### BRIEF SUMMARY OF THE INVENTION

The sound collector of this invention comprises: multiple microphones arrayed in the predetermined form and oriented to the direction of a sound collection object, and designed to collect sound from the sound collection object; and a microphone choice control unit which selects at least one of the multiple microphones, drives the selected microphone, outputs the aural signal collected and extracted from the sound collection object; wherein the microphones are optical microphones comprising: a diaphragm which oscillates by the sound pressure; a light source which irradiates a light beam in the diaphragm; a photodetector which receives the reflection light of the light beam irradiated in the diaphragm and outputs the signal which copes with the oscillation of the diaphragm; and a light source drive circuit that drives to supply predetermined electric current to the above light source; and wherein the aural signal is outputted through a negative feedback circuit that supplies a part of the aural signal from the optical microphone selected by the choice control unit to the light source drive circuit as a negative feedback signal. In another sound collector of this invention, the gain of negative feedback by the above negative feedback circuit can be varied. In still another sound collector of this invention, the microphone choice control unit can toggle the microphone electrically at the predetermined timing.

### BRIEF DESCRIPTION OF THE DRAWINGS

FIG. 1 is a circuit diagram that shows one embodiment of the sound collector of this invention.

FIG. 2 shows a gradation of a directivity response pattern of an optical microphone element to use for this invention.

FIG. 3 shows a structure of an optical microphone element to use for this invention.

FIG. 4 shows a structure of another optical microphone element used for this invention.

FIG. 5 is a circuit diagram that shows an outline configuration of an optical microphone device to use for this invention.

FIG. 6 is a gradation figure of a directivity response pattern of an optical microphone element of FIG. 4.

FIG. 7 is a directional characteristics pattern figure of an optical microphone element used for this invention.

FIG. 8 shows an outline configuration of the conventional sound collector.

In these figures, 2 is diaphragm, 3 is light source, 5 is photodetector, 7 is sound wave, 13 is light source drive circuit, 50 is optical microphone element, 60 is choice control unit, and 100 is negative feedback circuit.

### DESCRIPTION OF THE SPECIFIC EMBODIMENTS

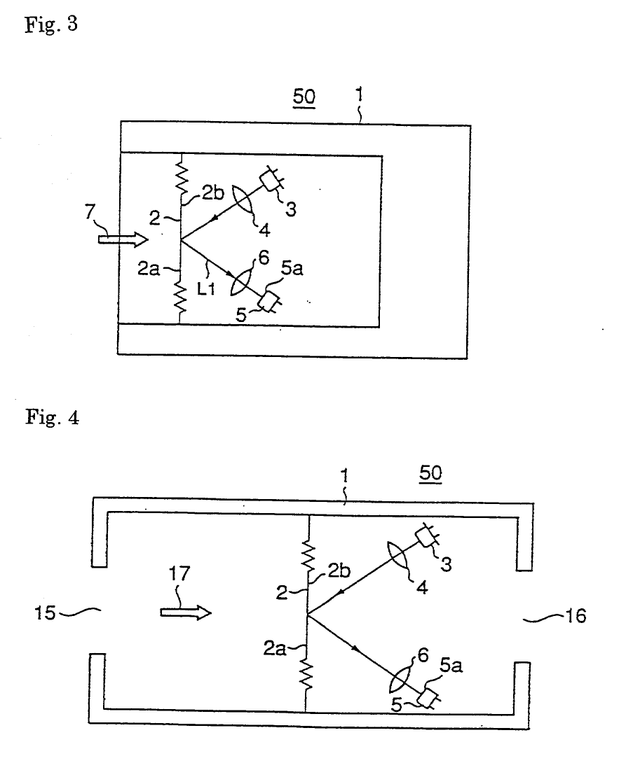

In the sound collector of this invention, optical microphones are used. Optical microphones can follow a variation of a weak sound wave, and have a high sensitivity and a broad band, which do not depend on a use environment as a microphone. First, an optical microphone is explained. FIG. 3 shows a structure of the head part of an optical microphone element 50. A diaphragm 2 which oscillates by a sound wave is provided in the microphone head 1, and a surface 2a at the side which a sound wave hits is exposed to the outside. Therefore, a sound wave 7 reaches this surface 2a, and oscillates this diaphragm 2. Inside the head 1 located in the opposite surface 2b of the diaphragm 2 against the surface 2a, a light source 3 such as LED irradiating a light beam in the surface 2b of the diaphragm 2, a lens 4 to make a light beam from this light source 3 predetermined beam shape, a photodetector 5 which receives the reflection light reflected in the surface 2b, and a lens 6 to zoom the displacement of the optical path of the reflection light caused by the oscillation of the diaphragm 2, are set up. When a sound wave 7 hits the surface 2a of the diaphragm 2 and a diaphragm 2 oscillates, the receiving position of the reflection light that enters to the receiving surface 5a of the photodetector 5 changes.

If a photodetector 5 is composed as a position sensor, an electric signal which met the oscillation of the diaphragm 2 from the irradiation location of the reflection light is taken out. This is the basic structure of the optical microphone. However, effect on a noise decrease can't be expected with the optical microphone that shows it in the FIG. 3 very much. This is because a diaphragm 2 also oscillates by the noise which reaches a diaphragm 2 and this is piled as a noise signal by oscillation by the usual sound wave 7.

As an optical microphone which reduces the influence of this noise and attempts effect on a noise decrease, a structure shown in FIG. 4 is known. In the structure shown in FIG. 4, the diaphragm 2, which oscillates by the sound wave 7, is provided in almost the center of the head 1. Then, on both sides of the head 1, a 1st opening 15 and a 2nd opening 16 are set up to become symmetrical location to each other. By composing it like this, a sound wave gets into the head 1 from the both openings to oscillate the diaphragm 2.

In the optical microphone element 50 shown in FIG. 4, when the phase and the amplitude of the sound wave from the 1st opening 15 and those of the sound wave from the 2nd opening 16 are equal, these two sound waves interfere with each other in both sides 2a and 2b of the diaphragm 2, and never oscillate the diaphragm 2. When two microphones that have equal sensitivities are arranged close and they receive the sound wave which occurred in the far range, the two microphone elements detect the sound wave equally.

Generally, a sound wave occurs from the mouth of the person in the short distance to the microphone element. In other words, most voice occurs at the short distance from this microphone element. The voice of the person of this short distance has globular field characteristics so that it may be shown by a circular curve. As for the sound wave by the noise sound which occurs in the far range has the characteristics of the plane field. Though the sound intensity of the globular wave is about the same along that spherical surface or the envelope and changes along the radius of that glob, sound intensity of the plane wave almost becomes the same in all the plane points.

As the optical microphone element shown in FIG. 4 can be thought to associate two microphone element, when this was put on the far range field, the sound waves which have almost the same amplitude and phase characteristics from the 1st opening 15 and the 2nd opening 16 comes in the diaphragm 2 to interfere with each other, and those influences are decreased. On the other hand, as a sound wave from the short distance field enters from the 1st opening 15 or the 2nd opening 16 non-uniformly, a sound wave from the short distance field oscillates a diaphragm 2, and it is taken out as a signal by the photodetector 5. The structure of FIG. 4 can provide the optical microphone element which reduces the influence of the noise more.

FIG. 7 shows directivity response patterns of the optical microphone element shown in FIG. 3 and FIG. 4. FIG. 7A shows a directivity response pattern of the optical microphone element 50 shown in FIG. 3. This optical microphone element 50 has an almost circular-shaped directivity response pattern, and has optimum sensitivity in the direction which is vertical to the diaphragm 2 toward the opening (the left side direction of the figure). FIG. 7B shows a directivity response pattern of the optical microphone element 50 shown in FIG. 4. This optical microphone element 50 has almost “8” shaped directivity response pattern, and has optimum sensitivity in both directions of the openings 15 and 16.

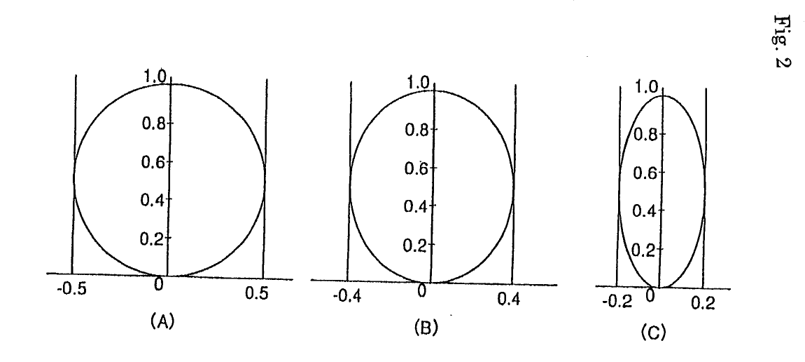

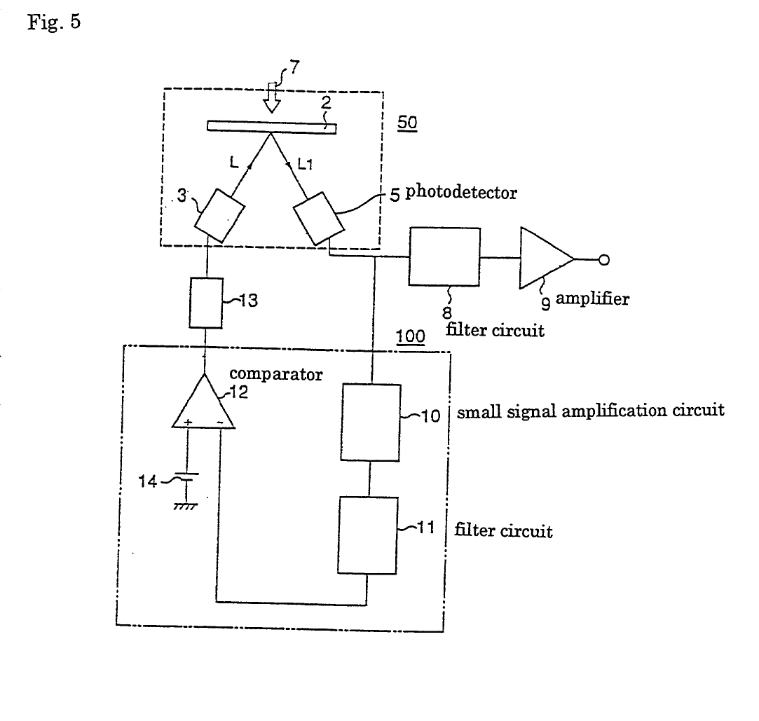

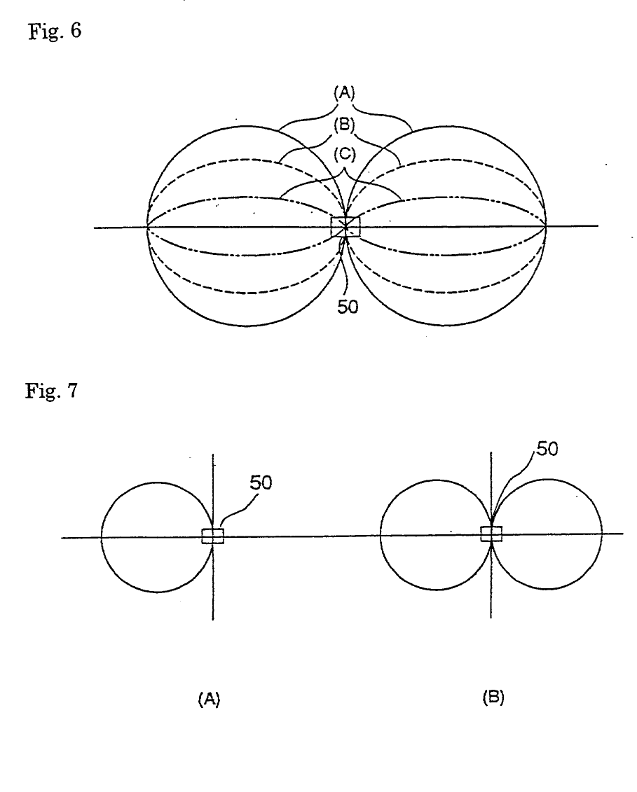

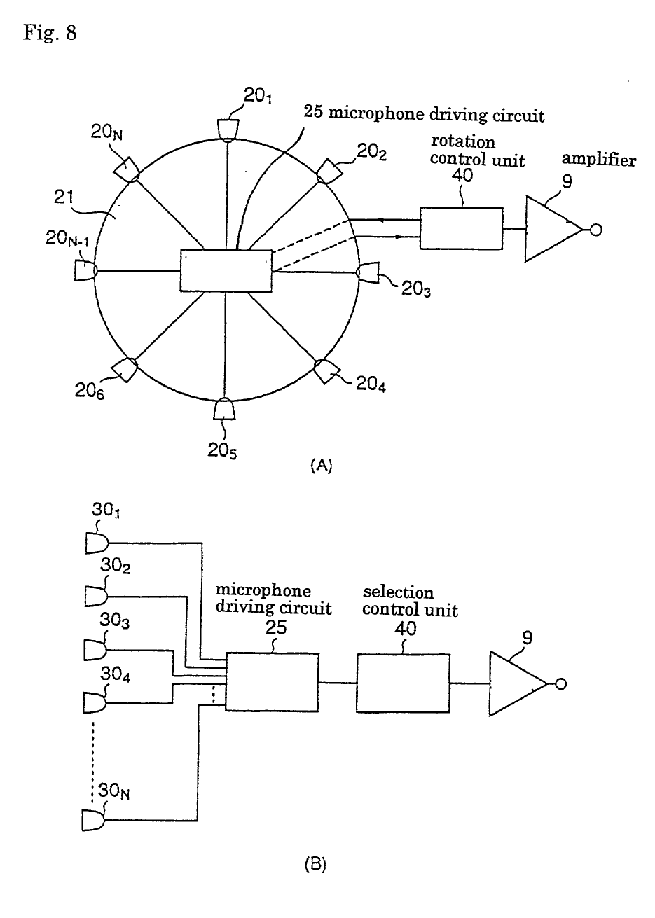

The directivity response pattern of the optical microphone element 50 shown in FIG. 3 and FIG. 4 can be stretched along the axis having optimum sensitivity as shown in FIG. 2 or FIG. 6. Also, the directivity response pattern can be narrowed along the direction which is vertical to the axis. To make the pattern of the directivity change like this, a part of the detection output from the photodetector 5 should be negatively feedbacked by using the negative feedback circuit to the light source drive circuit that drives light source 3. FIG. 5 shows an outline configuration of an optical microphone device which used a feedback circuit 100 to make a beam pattern change such as FIG. 2 or FIG. 6.

Output from the photodetector 5 is taken out through the filter circuit 8, amplified by an amplifier 9, and it becomes microphone output. A filter circuit 8 is used to take out a requested signal component of the frequency range. Here, with the optical microphone device shown in FIG. 5, it is composed to supply a part of the output signal taken out from this photodetector 5 to the light source drive circuit 13 through the negative feedback (NFB) circuit 100 as a negative feedback signal. Light source drive circuit 13 drives this light source 3 by supplying predetermined electric current to the light source 3.

Negative feedback circuit 100 comprises a small signal amplification circuit 10, a filter circuit 11 which takes out a signal component of the requested frequency range from the output from the small signal amplification circuit 10, and a comparator 12. A norm power source 14 which provides reference voltage is connected to the non-inversion input terminal of the comparator 12. The signal taken out through the filter circuit 11 is supplied to the reverse input terminal of the comparator 12. When it is composed like this, a little output level is outputted as much as the output of the filter circuit 11 of the comparator 12 is big, and light source drive circuit 13 is actuated by this to reduce electric current supplied to the light source 3.

Only when an input signal level is less than a predetermined level, small signal amplification circuit 10 amplifies that signal, and a certain signal beyond the level is not amplified. Therefore, an output signal level doesn't change in the case the input signal level is beyond a predetermined level, and amplification degree (gain) becomes 0. When an input signal is less than a predetermined signal level, it amplifies so that amplification degree may grow big as much as a signal level is small. Furthermore, the rate of increase of the output signal toward the input signal rises as much as an input signal level is small. As an output from the photodetector 5 is in proportion to the received sound volume, the output of the small signal amplification circuit 10 is greatly amplified and outputted.

Because this output is being inputted to the reverse input terminal of the comparator 12 through the filter circuit 11, the output of the comparator 12 decreases conversely as much as small sound volume. As that result, the electric current supplied to the light source 3 is actuated so that small sound volume may make the optical output of the light source 3 decline. Id est, the sensitivity of the microphone declines as much as small sound volume. As a signal beyond the predetermined level isn't amplified, optical output isn't restricted by that signal level. Therefore the sensitivity of the microphone never declines.

When the sound which came from the axis direction which was vertical to the diaphragm and which has a volume that does not cause the sensitivity decline of the microphone is moved from the axis direction, sensitivity gradually declines along the original directivity response pattern curve. Then, when the sensitivity becomes less than a certain level, small signal amplification circuit 10 comes to have amplification degree, and the electric current control of the light source drive circuit 13 works, and the sensitivity of the microphone declines more. As this result, with the optical microphone device which has negative feedback circuit 100, the width of the directivity beam is more limited than the directivity response pattern of the sensitivity as shown in FIG. 2 and FIG. 6.

FIG. 2 and FIG. 6 show pattern gradations of directivity by changing the gain of negative feedback. In these figures, (A) shows the directivity response pattern when negative feedback isn't made, and almost becomes a circular directivity response pattern in this case. Next, directivity response patterns under negative feedback are shown in (B) and (C). The gain of negative feedback is small in the case of (B), and the gain of negative feedback is big in the case of (C). As shown in these figures, the gain of negative feedback is made to change by varying the amplification degree of the small signal amplification circuit 10. The directivity response pattern of the sensitivity can be stretched along the axis direction of the optimum sensitivity by this, or narrowed in the direction that is vertical to the axis. Thus, the directional characteristics of the sensitivity of the optical microphone can be changed.

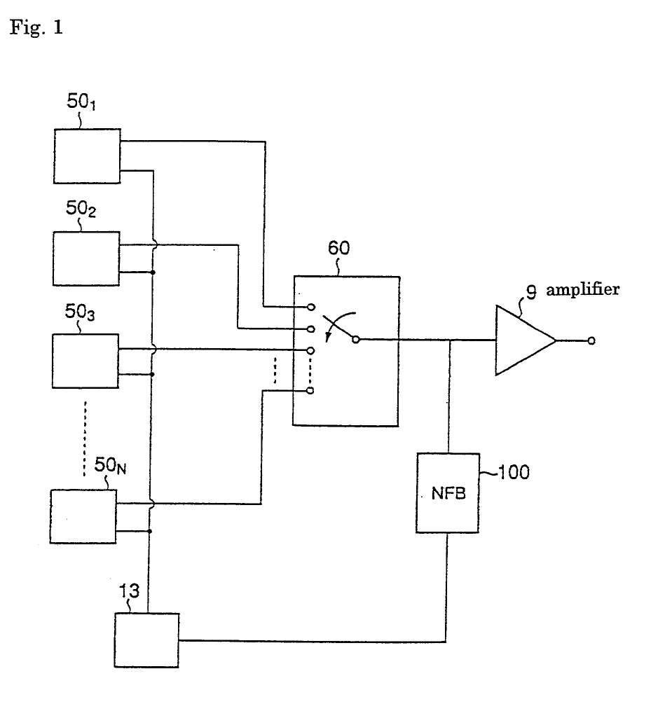

The sound collector of this invention changes the directional characteristics of the selected microphone by using the optical microphone that may change the beam pattern of directivity. FIG. 1 is a circuit diagram of one embodiment of the sound collector of this invention. The optical microphone element 50₁, 50₂, 50₃, . . . 50_{N} which has the structure shown in FIG. 3 or FIG. 4 are arrayed in circular or in a plane. A detection signal from each optical microphone element is supplied to each of the microphone choice control unit 60. The light source drive circuit 13 that drives microphone element 50 is connected to the light source 3 (now shown) in each optical microphone element. The signal selected by the choice control unit 60 is taken out, and audio output is taken out by the amplifier 9. A part of the output signal from the choice control unit 60 is negatively feedbacked by light source drive circuit 13 through the negative feedback circuit 100.

The gain of negative feedback depends on a setting of the amplification degree of the small signal amplification circuit 10 (not shown) inside the negative feedback circuit 100 in the predetermined value, and the optical microphone which had the directivity response pattern depending on the gain of negative feedback is formed. The choice of microphone by the microphone choice control unit 60 is performed by electrically changing microphone element and suspending this change automatically when microphone elements in the direction of the specific sound collection object are selected. In this composition, microphones which are in the direction of the specific sound collection object are selected, and predetermined negative feedback is made by the negative feedback circuit 100 toward this microphone. Therefore, the directivity of the microphone sensitivity becomes limited. Therefore, sound from specific speaker is detected, and ambient noise can be decreased. In the embodiment shown in FIG. 1, only one negative feedback circuit 100 is provided, and this negative feedback circuit 100 is commonly used for each microphone element. However, multiple negative feedback circuits may also be provided and selected in accordance with the use.

Namely, to pick out voice from the distance, a negative feedback circuit having high gain of negative feedback is chosen to make the beam sharp. To pick out a sound wave from the short distance, another negative feedback circuit may be chosen to make the beam width wide. An optical microphone element 50 shown in FIG. 4 that receives sound wave from two directions may also be used as well as device 50 shown in FIG. 3. When the optical microphone element shown in FIG. 4 is used, a sound collector having an excellent sound collecting character can be realized to exclude the influence of the ambient noise.

As explained above, optical microphone is used in this invention and a part of the aural signal from the selected optical microphone is made a negative feedback signal, and the negative feedback signal is supplied to the light source drive circuit that the optical microphone is driven. Therefore, a directivity beam can be wrung and sound wave from the selected sound collection object may be taken out effectively without the influence of the surroundings noise.

What is claimed is:

1. A sound collector comprising:
multiple microphones arrayed in the predetermined form and oriented to the direction of a sound collection object, and designed to collect sound from the sound collection object; and
a microphone choice control unit which selects at least one of the multiple microphones, drives the selected microphone, outputs the aural signal collected and extracted from the sound collection object;
wherein the microphones are optical microphones comprising:
a diaphragm which oscillates by the sound pressure;
a light source which irradiates a light beam in the diaphragm;
a photodetector which receives the reflection light of the light beam irradiated in the diaphragm and outputs the signal which copes with the oscillation of the diaphragm; and
a light source drive circuit that drives to supply predetermined electric current to the above light source; and
wherein the aural signal is outputted through a negative feedback circuit that supplies a part of the aural signal from the optical microphone selected by the choice control unit to the light source drive circuit as a negative feedback signal.

2. The sound collector according to claim 1, wherein the gain of negative feedback by the above negative feedback circuit can be varied.

3. The sound collector according to claim 1 or 2, wherein the microphone choice control unit can toggle the microphone electrically at the predetermined timing.
